(19) United States
(12) Patent Application Publication
(10) Pub. No.: US 2006/0203799 A1
(43) Pub. Date: Sep. 14, 2006

(54) Method and circuit for reading data from a data carrier

(75) Inventors: Victor Wee Teck Tan, Singapore (SG); Siew Tan Chong, Singapore (SG); Hsi Choong Ho, Singapore (SG)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/562,291

(22) PCT Filed: Jun. 23, 2004
(86) PCT No.: PCT/IB04/50980

§ 371 Date: Dec. 22, 2005

(30) Foreign Application Priority Data
Jun. 27, 2003 (EP) 03101929.2

(51) Int. Cl. H04L 12/66

(52) U.S. Cl. 370/352

(57) ABSTRACT

The invention provides a circuit for reading data from a data carrier, the circuit comprising a reading unit for reading data from the data carrier; and a controller for controlling the circuit. The circuit further comprises a detection unit for detecting a format of the data carrier; and the controller is configurable to control the circuit to read data from the data carrier in accordance with the detected data carrier format. In this way, for example, an ATAPI engine can be used in a consumer electronics device to play back music from a Super Audio CD. The invention also provides an apparatus, method and data carrier.

The invention relates to a circuit for reading data from a data carrier, the circuit comprising a reading unit for reading data from the data carrier and a controller for controlling the circuit.

The invention further relates to an apparatus for processing data comprising a host system for processing the data read from a data carrier and means for receiving the data carrier.

The invention also relates to a method of reading data from a data carrier. Furthermore, the invention relates to a data carrier comprising data for configuring a processing unit.

Such a circuit is known from granted U.S. Pat. No. 5,809,245; this document discloses a DVD-ROM drive connected to an ATAPI interface.

Standard ATAPI drives can be used to read data from discs on which data is stored in accordance with various formats, like the Digital Versatile Disc® (DVD) and the Compact Disc® (CD). However, another increasingly popular data format, the Super Audio Compact Disc® (SACD), cannot be read by a standard ATAPI drive. One of the reasons for this is the encryption used on the SACD. This is unfortunate, since the industrial de facto standard for the interface between the drive (or engine) and a back-end MPEG decoder decoding data from the DVD is the ATAPI interface. Devices capable of playing both DVD and SACD in one drive are known in the art, but they are not equipped with ATAPI drives.

It is an object of the invention to provide a circuit that enhances the versatility of a drive that has initially been designed to handle a limited number of disc formats.

This object is achieved by the circuit according to the invention, which is characterized in that the circuit further comprises a detection unit for detecting a format of the data carrier; and the reading unit is configurable to control the circuit to read data from the data carrier in accordance with the detected data carrier format.

In known cases, for example, when an SACD disc is inserted in an ATAPI drive, the data read from the disc may not be directly fit for processing, or certain preconditions—different from standard—have to be satisfied. However, it can be detected that the disc is a disc different from the standard—for example, an SACD disc. Using this information, the controller can be configured to read the data from the non-standard disc and/or convert the data read from the non-standard disc as if the data was read from a standard disc. In this way, the drive can be applied in more applications than it was originally designed for.

The apparatus according to the invention is characterized in that the apparatus comprises the circuit as defined in claim 1.

In an embodiment of the apparatus according to the invention, the reading unit is an ATAPI drive; the multiple data carriers formats comprise Super Audio Compact Disc and Digital Versatile Disc; and the host comprises a Super Audio Compact Disc data decoder and an MPEG video data decoder.

The advantages of this embodiment have been described above.

In another embodiment of the apparatus according to the invention, based on the previous embodiment, the ATAPI drive is connected to the MPEG video data decoder and to the Super Audio Compact Disc data decoder via a standard ATAPI interface. In a further embodiment of the apparatus according to the invention, the ATAPI drive is further connected to the Super Audio Compact Disc data decoder via an extra 2-pin connector for transferring an additional signal from the ATAPI drive to the Super Audio Compact Disc data decoder.

For full proper functioning, the SACD decoder requires more signals than are provided by the ATAPI interface. In a preferred embodiment of the invention, the extra signal is provided, using an extra 2-pin connector. The advantage of this embodiment is that the signal has a separate ground, providing a good signal quality.

In yet a further embodiment of the apparatus according to the invention, the spare pin of the ATAPI interface is used to transfer an additional signal from the ATAPI drive to the Super Audio Compact Disc data decoder.

Although using an extra 2-pin connector for providing the extra signal from the drive to the SACD decoder is the best solution with respect to signal quality, also the spare pin of the ATAPI can be used. This solution is cheaper, because no extra connection is needed, but the signal quality is somewhat less.

The invention will now be described in more detail with reference to the sole FIGURE, which shows an embodiment of the apparatus according to the invention.

The FIGURE shows an apparatus 100 as an embodiment of the apparatus according to the invention for retrieval of data from a disc 190 and rendering of the retrieved data for reproduction. The apparatus 100 comprises an ATAPI disc drive unit 110, an MPEG decoder 120, a Super Audio Compact Disc decoder 122, a D/A converter 124, a connector 126, a user command receiver 130, a central processing unit 140 and a first ROM memory 150. In a preferred embodiment of the apparatus according to the invention, the central processing unit is comprised by the MPEG decoder 120.

The ATAPI disc drive unit 110 comprises a mechanical drive system 111 comprising a spindle 112 for rotating the disc 190 and an optical pick-up unit 114 for retrieving data from the disc 190. The optical pick-up unit is connected to a drive controller 116 that is configured to convert raw data read from the disc 190 to a format that can either be handled by the MPEG decoder 120 or the Super Audio Compact Disc decoder 122. The ATAPI disc drive unit 110 further comprises a second ROM memory 118 for storing firmware to configure the drive controller 116. The mechanical drive system 111 also comprises a servosystem for controlling the position of the optical pick-up unit 114. However, this is not shown to keep the FIGURE simple.

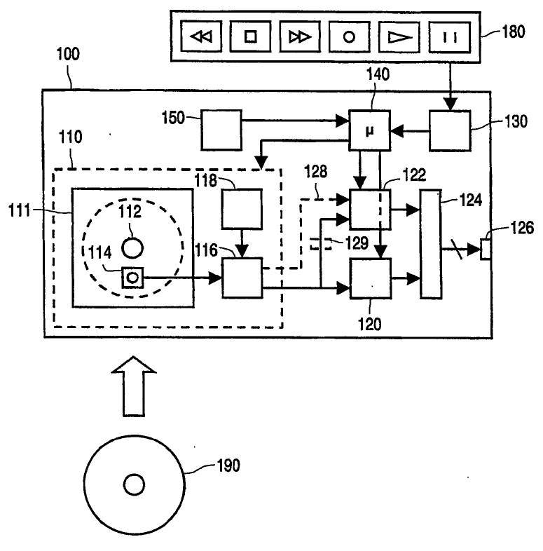

FIG. 1 further shows a user control device 180 for controlling the apparatus 100. Control signals from the user control device 180 are transferred to the user command receiver 130, which transfers the user commands to the central processing unit 140. The central processing unit 140 controls the various components of the apparatus 100. The first ROM memory 150 is used for storing data to program the central processing unit 140 to carry out the method according to the invention. The user control device 180 may be embodied as a remote control device. In a further embodiment, the user control device 180 is comprised by the apparatus 100.

The ATAPI disc drive unit 110 is conceived to receive—among others—discs that carry data in accordance with the Digital Versatile Disc (or DVD) standard and discs that carry data in accordance with the Compact Disc (or CD) standard. The ATAPI disc drive unit 110, however, is not directly designed to retrieve and handle data as stored on discs in accordance with the Super Audio Compact Disc standard.

An important difference between DVD and SACD is that, for DVD, all data is stored in one layer of the optical disc. Although dual-layer DVD discs are known, still only data of one layer is needed for rendering of the data stored, and both layers have more or less the same structure. SACD discs, however, may have data stored in two different layers: a conventional Compact Disc layer and a high-definition layer. These types of SACD discs are called Dual layer SACDs. Dual layer SACDs comprise a high-density (HD) layer and a normal CD (CDDA) layer. The CDDA layer is added to enable the SACD to be backward compatible with an ordinary CD player.

For handling of the data, data from both layers has to be retrieved, which is called hybrid disc handling. For this purpose, switching between CD and HD layer is needed. Furthermore, for SACD, the sectors have to be addressed, using logical sector addresses, instead of absolute (compared to DVD). Thirdly, the detection and decryption of the SACD mark have to be handled, which is not possible when using a standard ATAPI drive. These three differences between the handling of SACD discs compared to DVD discs have to be handled by the drive controller 116.

To adapt the drive decoder to properly handle SACD discs, the drive controller 116 can be programmed by using data stored in the second ROM memory 118. This action is performed when it is detected that a disc inserted in the mechanical drive system 111 is an SACD disc. Detection whether the inserted disc is an SACD disc is done by checking for the presence of a PSP (pit signal processing for copy protection). This is done by the servo (not shown) sending the info back via an additional interface path for RF info. This info is then passed to the SACD decoder 122 which detects whether the disc is an SACD or has another format.

When the inserted disc is detected to have data stored in accordance with the SACD standard, the appropriate data is loaded from the second ROM memory 118 and used to program the drive controller 116.

However, when the inserted disc has data stored in accordance with the DVD standard, it is handled as a standard DVD disc and data stored on the disc is retrieved and handled accordingly.

When handling an SACD disc using the ATAPI disc drive unit 110, however, an additional problem pops up, apart from the ones just mentioned. Proper SACD data retrieval and handling needs an additional signal, which is the EFM+ signal which contains the decryption key necessary for SACD data retrieval. For this purpose, an extra connection between the ATAPI disc drive unit 110 and the SACD decoder is needed. In an embodiment of the invention, an extra 2-pin connection 128 is used for the transfer of the EFM+ signal. In a further embodiment of the invention, the EFM+ signal is transferred by using the spare pin of the ATAPI interface, which is pin 40. The use of the extra 2-pin connection is preferred to using the spare pin of the ATAPI interface, because it provides the best signal quality.

Furthermore, to translate data from the ATAPI disc drive unit 110 to be processed by the SACD decoder 122 in the preferred embodiment, in which the SACD decoder 122 is a Furore 2, a conversion unit 129 must be inserted to convert the 16-bit information words coming from the ATAPI disc drive unit 110 to 8-bit words.

When the disc 190 is recognized as having data stored in accordance with the DVD standard, the drive controller 116 is programmed accordingly (or not programmed, because the handling is in accordance with standard procedures) and data is read from the disc 190 by the optical pick-up unit 114. The data read is handled by the drive controller 116 and sent to the MPEG decoder 120. The MPEG decoder 120 renders the data received from the ATAPI disc drive unit 110 and provides an uncompressed signal to the D/A converter 124. The D/A converter 124 converts the rendered digital signal to a signal complying with e.g. the PAL standard that can be presented by a TV set that can be connected to the apparatus 100 by means of the connector 126.

However, when the disc 190 is recognized as having data stored in accordance with the SACD standard, the drive controller 116 is also programmed accordingly and data is read from the disc 190 by the optical pick-up unit 114. The data read is handled by the drive controller 116 and acquired by the SACD decoder 122 via the conversion unit 129. Also, the EFM+ signal is communicated to the SACD decoder 122 via the extra 2-pin connection 128. The data received from the ATAPI disc drive unit 110 is rendered, thus also decrypted, by the SACD decoder 122 and applied to the D/A converter 124. From this point onwards, data is handled in the same way as when data would have been retrieved from a DVD disc, as described above.

Although the invention has been described by means of a very specific embodiment, it will be apparent to a person skilled in the art that the scope of the invention is not limited to this embodiment only. Mere modifications of the embodiments of the apparatus of the invention disclosed are possible without departing from the scope of the invention. For example, the various processors may each be combined to one central processing unit. Also, the unit performing multiple functions in the embodiments described may also be split into multiple processor units performing only one of the functions.

Furthermore, the invention may also be applied in apparatuses reading data from other kinds of media like smart cards or flash memory cards and removable harddisk drives. Although flash memory cards have various form factors, they can be fit in an adapter and put in a slot fit for another memory card.

1. A circuit (110) for reading data from a data carrier (190), the circuit comprising
(a) a reading unit (114) for reading data from the data carrier; and
(b) a controller (116) for controlling the circuit;
characterized in that
(c) the circuit further comprises a detection unit (116) for detecting a format of the data carrier; and
(d) the controller is configurable to control the circuit to read data from the data carrier in accordance with the detected data carrier format.

2. A circuit as claimed in claim 1, wherein the circuit further comprises a memory (118) for storing multiple data portions for configuring the configurable reading unit to read data in accordance with the detected data carrier format from the data carrier.

3. An apparatus (100) for processing data, comprising:
(a) a host system (140, 122, 120) for processing the data read from a data carrier;
(b) means (111) for receiving the data carrier; and
(c) the circuit as claimed in claim 1.

4. An apparatus as claimed in claim 3, wherein:
(a) the reading unit is an ATAPI drive;
(b) the multiple data carrier formats comprise Super Audio Compact Disc and Digital Versatile Disc; and
(c) the host comprises a Super Audio Compact Disc data decoder and an MPEG video data decoder.

5. An apparatus as claimed in claim 4, wherein the ATAPI drive is connected to the MPEG video data decoder and to the Super Audio Compact Disc data decoder via a standard ATAPI interface.

6. An apparatus as claimed in claim 5, wherein the ATAPI drive is further connected to the Super Audio Compact Disc data decoder via an extra 2-pin connector for transferring an additional signal from the ATAPI drive to the Super Audio Compact Disc data decoder.

7. An apparatus as claimed in claim 5, wherein the spare pin of the ATAPI interface is used to transfer an additional signal from the ATAPI drive to the Super Audio Compact Disc data decoder.

8. An apparatus as claimed in claim 6 or 7, wherein the additional signal is the EFM+ signal.

9. An apparatus as claimed in claim 4, wherein, in case the detected data carrier is a Super Audio Compact Disc, the ATAPI drive is configured to:
(a) detect and decrypt the Super Audio Compact Disc mark;
(b) interpret information in accordance with the Super Audio Compact Disc standard; and
(c) perform hybrid disc handling.

10. A method of reading data from a data carrier (190), characterized in that the method comprises the steps of:
(a) detecting the format of a data carrier from which data is to be read;
(b) configuring the reading circuit for reading data from the data carrier in accordance with the detected data carrier format; and
(c) reading data from the data carrier in accordance with the detected data carrier format.

11. A data carrier (150) comprising data for configuring a processing unit to perform the method as claimed in claim 10.
